(19) United States
(12) Patent Application Publication
(10) Pub. No.: US 2012/0025728 A1
(43) Pub. Date: Feb. 2, 2012

(54) HID LAMP IGNITOR

(75) Inventors: Naveen Tumula, Lake Zurich, IL (US); Yimin Chen, Palatine, IL (US); Jerzy Janczak, Libertyville, IL (US); Joseph Christian Jansen, Eindhoven (NL)

(73) Assignee: KONINKLIJKE PHILIPS ELECTRONICS N.V., EINDHOVEN (NL)

(21) Appl. No.: 13/262,654

(22) PCT Filed: Mar. 11, 2010
(86) PCT No.: PCT/IB2010/051065

§ 371 Date: Oct. 4, 2011

Related U.S. Application Data
(60) Provisional application No. 61/166,864, filed on Apr. 6, 2009.

(51) Int. Cl. H05B 41/36

(52) U.S. Cl. 315/221

(57) ABSTRACT

An HID lamp ignitor for a lamp including a transformer (92) having a primary winding (94) inductively coupled to a secondary winding (96) operably connected to a lamp output (98); a first switch circuit (100) operably connected between DC voltage (102) and a junction point (104), the first switch circuit (100) being responsive to a first switch signal (112); a second switch circuit (120) operably connected between the junction point (104) and common (124), the second switch circuit (120) being responsive to a second switch signal (132); and an LC tank circuit (140) having the primary winding (94) operably connected in series with a capacitor (142), the LC tank circuit (140) being operably connected between the junction point (104) and the common (124). The first switch signal (112) alternates with the second switch signal (132) to close the first switch circuit (100) and the second switch circuit (120).

The technical field of this disclosure is ignition circuits for lamps, particularly, ignitors for high intensity discharge (HID) lamps.

High Intensity Discharge (HID) lamps, such as mercury vapor, metal halide, high-pressure sodium and low-pressure sodium light sources, are used for a variety of lighting tasks. The HID lamps can be electrically driven by electromagnetic or electronic ballasts. The HID lamp resistance is large when the lamp is off, so a large voltage from an ignition circuit must be applied to the lamp to start the lamp. Unfortunately, conventional ignition circuits present a number of limitations.

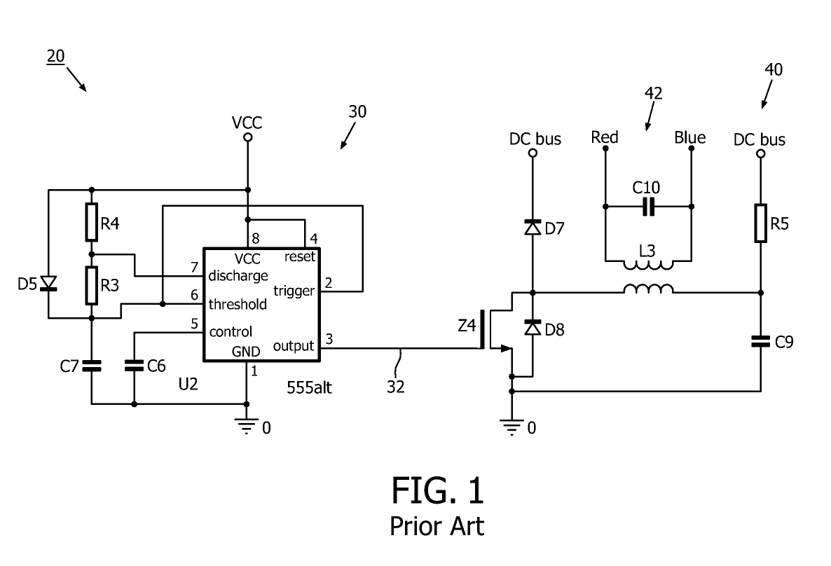

FIG. 1 is a schematic diagram of an ignitor for an HID lamp. The ignitor 20 includes a timer circuit 30 and a high voltage (HV) pulse circuit 40. The timer circuit 30 generates a series of narrow trigger signals 32, which are provided to the HV pulse circuit 40. The HV pulse circuit 40 generates a HV pulse at the lamp output 42 in response to the trigger signal 32.

In operation, capacitor C9 in the HV pulse circuit 40 charges to DC bus voltage through resistor R5. When the narrow trigger signal 32 turns on switch Z4, the capacitor C9 and primary winding of transformer L3 form an LC tank circuit. Current oscillates through the primary winding of transformer L3 by travelling through the switch Z4 in one direction and through the diode D8 in the opposite direction. Transformer L3 is a boost transformer, so the oscillating current generates the HV pulse at the lamp output 42 to ignite the lamp. After the trigger signal 32 turns off the switch Z4, the capacitor C9 charges again to DC bus voltage through the resistor R5 and the cycle can repeat. The charging time is longer than the time that the trigger pulse turns on the switch Z4 to allow the capacitor C9 to fully charge.

The component limitations in the ignitor 20 restrict the pulse repetition rate which can be achieved from the ignitor 20. The capacitance of capacitor C9 is selected to provide the desired high voltage for the HV pulse at the lamp output 42. The resistance value of resistor R5 determines how quickly the capacitor C9 can be charged, so a small resistance is required when a high pulse repetition rate is desired. The pulse repetition rate, defined as the number of times capacitor C9 can be discharged in one second and corresponds to the HV pulse rate. Unfortunately, a high repetition rate deposits more energy in the small resistor R5 than it can dissipate, damaging the resistor R5. Therefore, resistor R5 must be sized to limit the pulse repetition rate and avoid damage, even though a high repetition rate and HV pulse rate is more effective in igniting the lamp. Conventional ignition circuits are typically limited to a repetition rate of less than 1 kHz.

Conventional ignition circuits are also affected by variations at the lamp output for parameters such as lead length and output circuit components. Such variations can reduce the ignition pulse voltage, making it difficult or impossible to light the lamp.

It would be desirable to have a HID lamp ignitor that would overcome the above disadvantages.

One aspect of the present invention provides an ignitor for a lamp including a transformer having a primary winding inductively coupled to a secondary winding, the secondary winding being operably connected to a lamp output operable to receive the lamp; a first switch circuit operably connected between DC voltage and a junction point, the first switch circuit being responsive to a first switch signal; a second switch circuit operably connected between the junction point and common, the second switch circuit being responsive to a second switch signal; and an LC tank circuit having the primary winding operably connected in series with a capacitor, the LC tank circuit being operably connected between the junction point and the common. The first switch signal alternates with the second switch signal to close the first switch circuit and the second switch circuit.

Another aspect of the present invention provides an ignitor for a lamp including a transformer having a primary winding inductively coupled to a secondary winding, the secondary winding being operably connected to a lamp output operable to receive the lamp; an LC tank circuit having the primary winding operably connected in series with a capacitor, the LC tank circuit being operably connected between a junction point and common; and means for switching the junction point between DC voltage and the common at a predetermined frequency.

Another aspect of the present invention provides an ignitor system for a lamp including a timer operable to generate a timing signal; a level shifter responsive to the timing signal to generate a first switch signal and a second switch signal; a transformer having a primary winding inductively coupled to a secondary winding, the secondary winding being operably connected to a lamp output operable to receive the lamp; a first switch circuit operably connected between DC voltage and a junction point, the first switch circuit having a first switch operably connected in parallel with a first diode, the first switch being responsive to the first switch signal, a first diode cathode of the first diode being operably connected to the DC voltage; a second switch circuit operably connected between the junction point and common, the second switch circuit having a second switch operably connected in parallel with a second diode, the second switch being responsive to the second switch signal, a second diode cathode of the second diode being operably connected to the junction point; and an LC tank circuit having the primary winding operably connected in series with a capacitor, the LC tank circuit being operably connected between the junction point and the common. The first switch signal alternates with the second switch signal to alternately close the first switch and the second switch.

The foregoing and other features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof.

FIG. 1 is a schematic diagram of an ignitor system for an HID lamp;

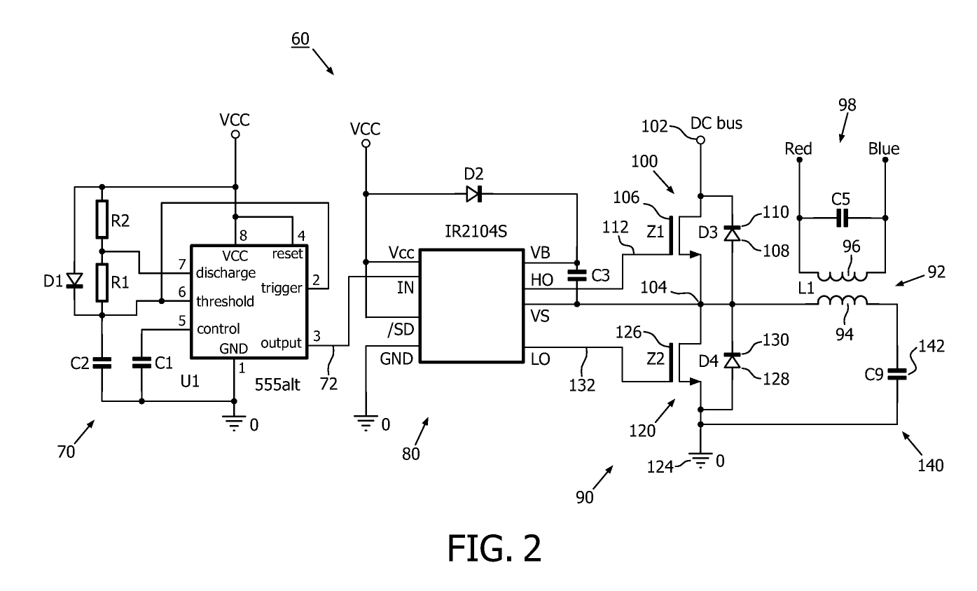

FIG. 2 is a schematic diagram of an ignitor system for an HID lamp in accordance with the present invention;

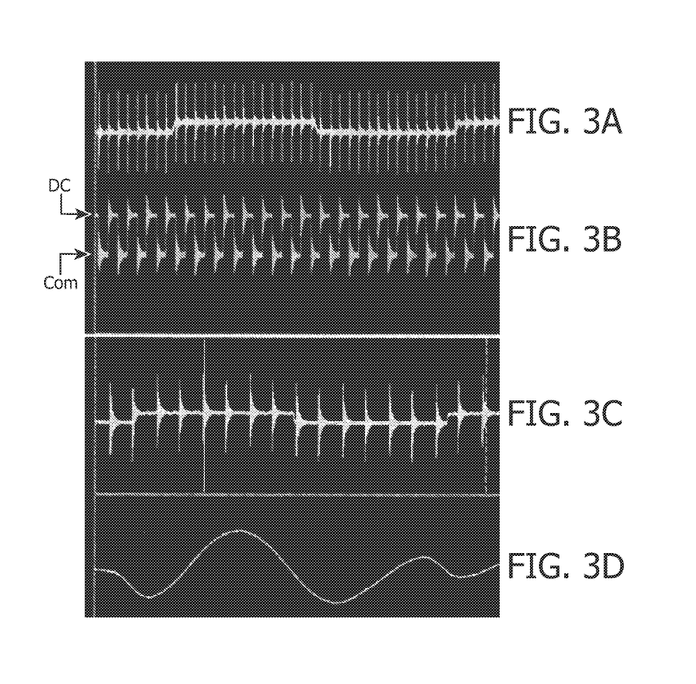

FIGS. 3A-3D are voltage traces for an ignitor for an HID lamp in accordance with the present invention;

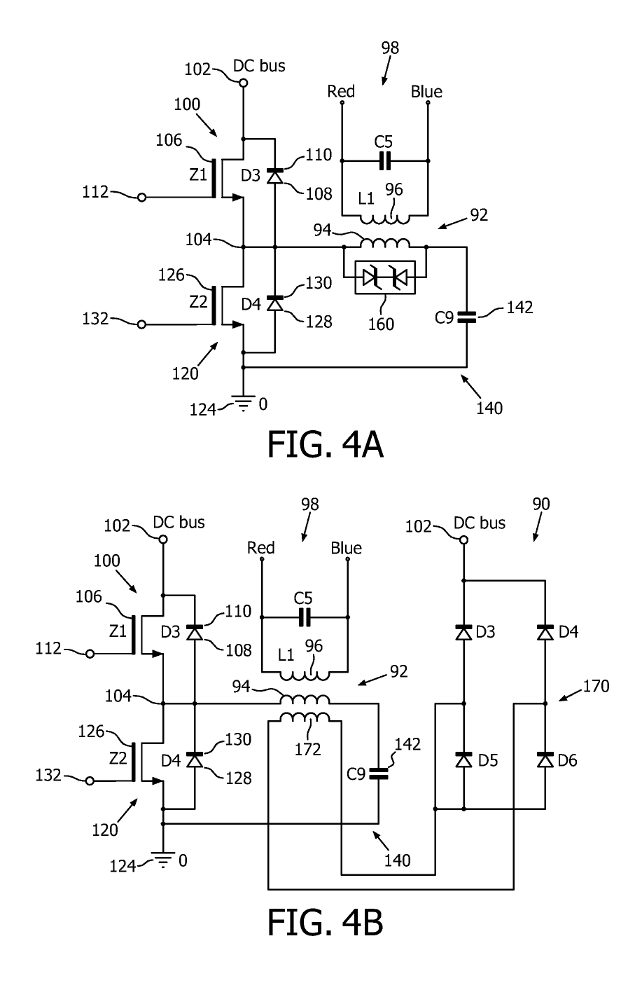

FIGS. 4A & 4B are schematic diagrams of an ignitor with a voltage limiter for an HID lamp in accordance with the present invention;

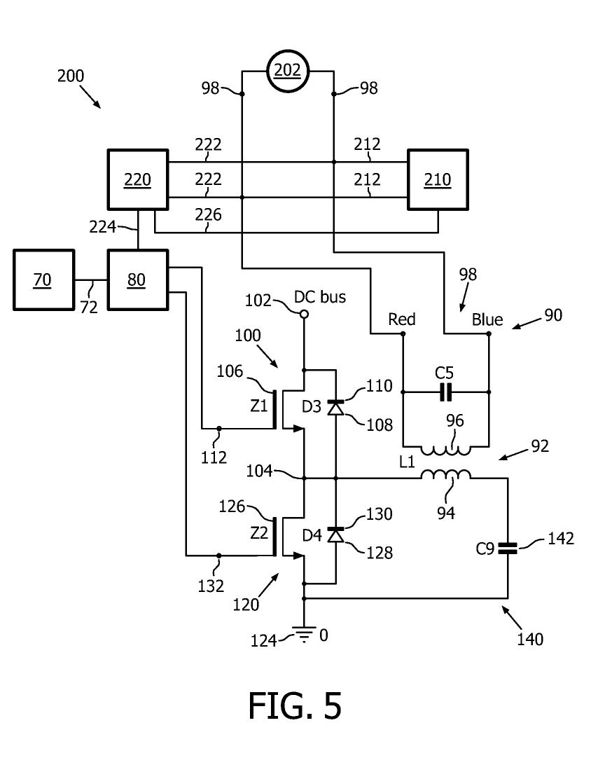

FIG. 5 is a schematic diagram of an ignitor system with lamp feedback for an HID lamp in accordance with the present invention;

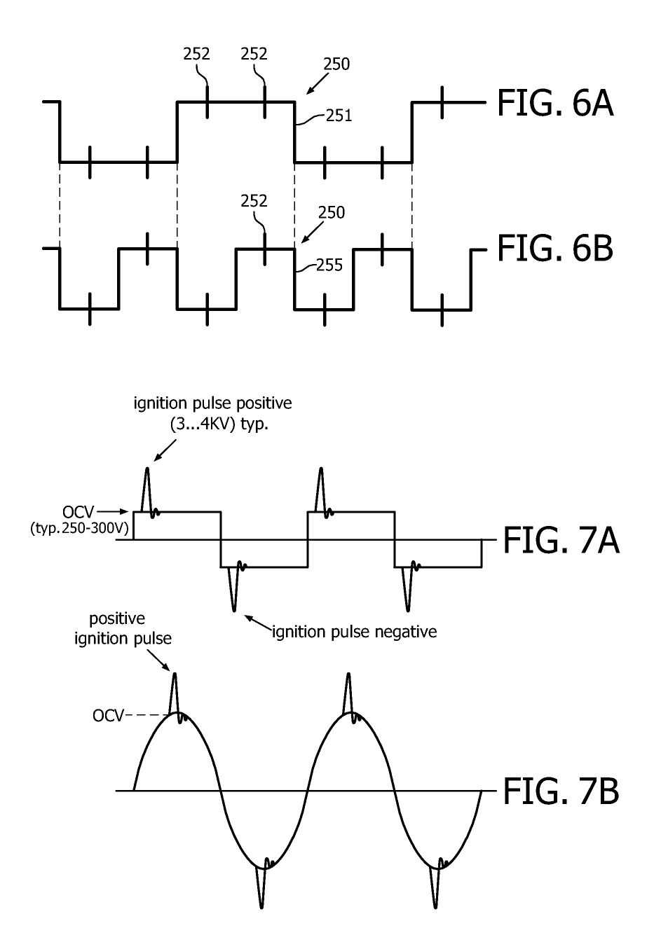

FIGS. 6A & 6B are voltage traces for an ignitor with lamp feedback for an HID lamp in accordance with the present invention;

FIGS. 7A & 7B are voltage traces for an ignitor with lamp feedback employing a pulse polarity mode and synchronization mode for an HID lamp in accordance with the present invention;

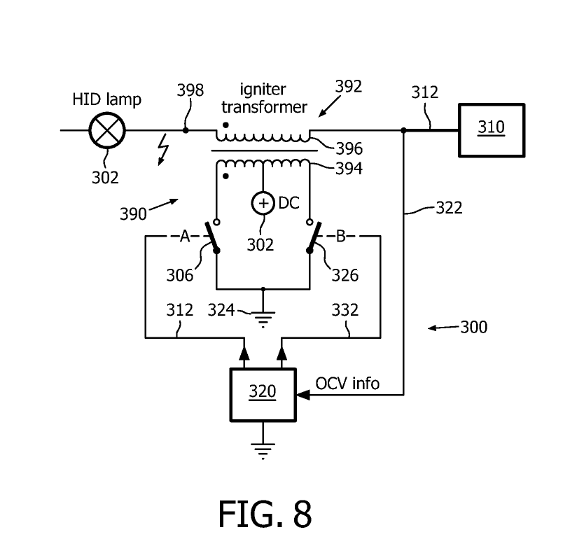

FIG. 8 is a schematic diagram of another embodiment of an ignitor for an HID lamp in accordance with the present invention.

FIG. 2 is a schematic diagram of an ignitor for an HID lamp in accordance with the present invention. The ignitor system 60 includes a timer 70, a level shifter 80, and an ignitor 90. Two switches in the ignitor 90 alternate with each other to alternately charge and discharge a LC tank circuit and provide a high voltage (HV) ignition pulse to a lamp.

The ignitor 90 includes a transformer 92, a first switch circuit 100, a second switch circuit 120, and an LC tank circuit 140. The transformer 92 has a primary winding 94 inductively coupled to a secondary winding 96. The secondary winding 96 is operably connected to a lamp output 98 operable to receive a lamp (not shown).

A pair of switch circuits switches a junction point to which the LC tank circuit is operably connected between DC voltage and common at a predetermined frequency. A first switch signal 112 from the level shifter 80 alternates with the second switch signal 132 from the level shifter 80 to alternately close a first switch 106 and a second switch 126. The first switch circuit 100 is operably connected between DC voltage 102 and a junction point 104. The first switch circuit 100 has the first switch 106 operably connected in parallel with a first diode 108. The first switch 106 is responsive to the first switch signal 112 and a first diode cathode 110 of the first diode 108 is operably connected to the DC voltage 102. The second switch circuit 120 is operably connected between the junction point 104 and common 124. The second switch circuit 120 has the second switch 126 operably connected in parallel with a second diode 128. The second switch 126 is responsive to the second switch signal 132 and a second diode cathode 130 of the second diode 128 is operably connected to the junction point 104.

The LC tank circuit 140 includes the primary winding 94 of the transformer 92 operably connected in series with a capacitor 142. The LC tank circuit 140 is operably connected between junction point 104 and common 124.

The timer 70 generates a timing signal 72, which is provided to the level shifter 80. The level shifter 80 generates the first switch signal 112 and the second switch signal 132 in response to a timing signal 72. The first switch signal 112 alternates with the second switch signal 132 to alternately close the first switch 106 and the second switch 126. The level shifter 80 can include an IR2104S half bridge driver integrated circuit. In one embodiment, the timing signal 72 is a square having a 50 percent duty cycle, i.e., the timing signal 72 is high for one half of a cycle and low for the other half of the cycle. The timer 70 can include a 555alt timer integrated circuit.

In operation, the timer 70 provides the square wave timing signal 72 to the level shifter 80, which alternately provides the first switch signal 112 and the second switch signal 132 to the first switch 106 and the second switch 126, respectively. When the first switch 106 is initially closed with the second switch 126 open, the DC voltage 102 is provided to the junction point 104 and across the LC tank circuit 140. The current through the LC tank circuit 140 charges the capacitor 142 and oscillates to induce an ignition pulse in the lamp through the transformer 92. Current passes alternately in one direction from the DC voltage 102 through the first switch 106 and in the opposite direction through the first diode 108. The second switch 126 is open and the second diode 128 blocks current flow from the junction point 104 to common 124 through the second switch circuit 120. The capacitor 142 charges to the voltage of the DC voltage 102.

The timer 70 changes the state of the timing signal 72, which causes the level shifter 80 to reverse the states of the first switch signal 112 and the second switch signal 132. This closes the first switch 106 and opens the second switch 126, so the junction point 104 is switched to common 124. The current through the LC tank circuit 140 discharges the voltage across the capacitor 142 and oscillates to induce an ignition pulse in the lamp through the transformer 92. Current passes alternately in one direction from the junction point 104 through the second switch 126 and in the opposite direction through the second diode 128. The first switch 106 is open and the first diode 108 blocks current flow from the DC voltage 102 junction point 104 to the junction point 104 through the second switch circuit 120. The capacitor 142 discharges to zero.

In another embodiment, the ignitor system 60 optionally includes an open circuit voltage (OCV) feedback circuit that monitors OCV at the lamp output 98.

FIGS. 3A-3D are voltage traces for an ignitor for an HID lamp in accordance with the present invention. The voltage traces are measured for the ignitor system of FIG. 2. In one example, the ignition pulse has a voltage of about 2.3 kV with a frequency of about 2 kHz as shown in FIGS. 3C & 3D. In another example, the frequency can be as high as about 4 kHz or the like as shown in FIGS. 3A & 3B. The maximum frequency achievable can be limited by tank current decay time. The first switch circuit 100 is turned on after the second switch circuit 120 current decays to zero, and vice versa, so in theory the maximum frequency equals 1/(2T_{decay}). In one embodiment, a small inductor can be placed in series with the LC tank circuit 140 to limit current change rate, such as between junction point 104 and the primary winding 94 of the transformer 92. Power dissipation in the small inductor increases with frequency, so the small inductor can limit maximum frequency in some embodiments.

FIG. 3A is a voltage trace across the lamp at the lamp output. The ignition pulse is superimposed on the more slowly cycling open circuit voltage provided by the lamp ballast. FIG. 3B is a voltage trace across the capacitor in the LC tank circuit. The voltage oscillates initially on each state change as the first and second switches alternately open to generate the ignition pulse at the lamp. After the initial oscillation peak, the voltage across the capacitor alternately decays to DC voltage or zero. FIGS. 3C & 3D are details on an expanded time scale of the voltage trace across the lamp at the lamp output.

FIGS. 4A & 4B, in which like elements share like reference numbers with FIG. 2, are schematic diagrams of an ignitor with a voltage limiter for an HID lamp in accordance with the present invention. The output compensation accounts for variations in lead length, output circuit components, and the like, by limiting the voltage across the primary of the transformer to a predetermined voltage. This assures that the ignition pulse is sufficient regardless of variations.

Referring to FIG. 4A, the ignitor 90 further includes a voltage limiter, which in this embodiment is a transient voltage suppressor (TVS) 160 operably connected in parallel with the primary winding 94 of the transformer 92. The TVS 160 conducts when the voltage across the primary winding 94 exceeds a predetermined voltage, so that the voltage at the lamp output 98 remains constant at the desired value. The predetermined voltage can be selected as desired for a particular application as desired by selecting a particular TVS. The TVS 160 dissipates energy from current through the TVS 160 as heat.

Referring to FIG. 4B, the ignitor 90 further includes a voltage limiter, which in this embodiment is a full wave bridge 170. The full wave bridge 170 is operably connected across the primary winding 94 of the transformer 92 through tertiary winding 172, and operably connected to the DC voltage 102. The full wave bridge 170 conducts when the voltage across the primary winding 94 exceeds a predetermined voltage, so that the voltage at the lamp output 98 remains constant at the desired value. The predetermined voltage can be selected as desired for a particular application by selecting the turns ratio between the primary winding 94 and the tertiary winding 172. The full wave bridge 170 returns energy from current through the full wave bridge 170 to the DC bus, so the energy is recovered.

In selecting the components for the ignitor with a voltage limiter, the longest lead wire desired at the lamp output or an equivalent capacitance can be specified. The capacitance of the capacitor in the LC tank circuit selected so the ignition pulse height at the lamp output is greater than or equal to the minimum desired pulse height. The lead wire at the lamp output or an equivalent capacitance can then be switched to the shortest lead wire desired. The predetermined voltage at which the voltage limiter conducts can be selected as the voltage which limits the ignition pulse height at the lamp output to the maximum desired pulse height. For the TVS, the voltage conduction value can be specified in selecting the TVS device. For the full wave bridge, the voltage conduction value can be selected by specifying the turns ratio between the primary and tertiary windings in the transformer in the LC tank circuit.

FIG. 5, in which like elements share like reference numbers with FIG. 2, is a schematic diagram of an ignitor system with lamp feedback for an HID lamp in accordance with the present invention. Lamp feedback allows the ignition pulses to be coordinated with the open circuit voltage to the lamp. The lamp ballast can operate in a frequency switching mode, a pulse polarity mode, and/or in a synchronization mode. Referring to FIG. 5, lamp ballast 200 provides power to a lamp 202 at lamp output 98. The lamp ballast 200 includes an ignitor system 60, which includes a timer 70, a level shifter 80, and an ignitor 90; a lamp power supply 210; and a lamp feedback circuit 220. The lamp power supply 210 provides AC power 212 to the lamp 202 during and after ignition. In one embodiment, the AC power 212 is a square wave. In another embodiment, the AC power 212 is a sine wave. The lamp feedback circuit 220 is responsive to an open circuit voltage (OCV) signal 222 from the lamp output 98 to generate a lamp operation state signal 226 provided to the lamp power supply 210 and/or a timing signal 224 provided to the level shifter 80.

In operation in a frequency switching mode, the lamp feedback circuit 220 monitors the OCV signal 222 to determine whether the lamp 202 is in startup or steady state operation, and sets the frequency of the AC power 212 to one frequency when the lamp 202 is in startup operation and another frequency when the lamp 202 is in steady state operation. In one embodiment, the frequency is lower when the lamp is in startup operation and higher when the lamp is in steady state operation.

During startup operation, the OCV signal 222 indicates the lamp 202 is off, i.e., the OCV is high, and the lamp feedback circuit 220 generates a lamp operation state signal 226 indicating the lamp 202 is off. The lamp power supply 210 is responsive to the lamp operation state signal 226 and sets the AC power 212 to a lower frequency. When the lamp is in steady state operation, the OCV signal 222 indicates the lamp 202 is on, i.e., the OCV is low, and the lamp feedback circuit 220 generates a lamp operation state signal 226 indicating the lamp 202 is on. The lamp power supply 210 is responsive to the lamp operation state signal 226 and sets the AC power 212 to a higher frequency. In one embodiment employing the frequency switching mode, the lamp ballast 200 is a low frequency square wave electronic ballast operating in accordance with the appropriate ANSI Standard.

FIGS. 6A & 6B are voltage traces for an ignitor with lamp feedback employing a frequency switching mode for an HID lamp in accordance with the present invention. FIG. 6A is an example of AC power voltage at a lower frequency when the lamp is in startup operation and FIG. 6B is an example of AC power voltage at a higher frequency when the lamp is in steady state operation. The frequency switching mode can be used to determine the number of ignition pulses that occur in each cycle of the AC power. The amplitude of the voltage is not to scale for clarity of illustration.

Referring to FIG. 6A, the AC power voltage 250 for the lamp in startup operation includes a square wave component 251 at a lower frequency with two ignition pulses 252 superimposed every half cycle. Referring to FIG. 6B, the AC power voltage 254 for the lamp in steady state operation includes a square wave component 255 at a higher frequency with one ignition pulse 252 superimposed every half cycle. The lower frequency is one half the higher frequency in this example. In one embodiment, the lower frequency is about 70 Hz, the higher frequency is about 140 Hz, the ignition pulse frequency is 280 Hz, the ignition pulse width is greater than 1.0 microseconds, and the ignition pulse voltage is about 2.7 kV. Those skilled in the art will appreciate that the parameters for the AC power and ignition pulses can be selected as desired for a particular application.

Referring to FIG. 5, in operation in a pulse polarity mode, the lamp feedback circuit 220 monitors the OCV signal 222 to determine whether the polarity of the AC power 212 is positive or negative, and sets the polarity of the ignition pulse to match the polarity of the AC power 212. Having the AC power and the ignition pulse of like polarity provides the greatest voltage to ignite the lamp since the momentary AC power voltage adds to the ignition pulse voltage, increasing the chance of ignition.

During startup operation, the lamp feedback circuit 220 monitors the OCV signal 222. When the polarity of the instantaneous OCV is positive, the timing signal 224 directs the level shifter 80 to close the first switch 106 and open the second switch 126, so the initial swing in the ignition pulse is positive. This adds the power pulse voltage to the instantaneous OCV. For example, when the instantaneous OCV is +300 Volts and the initial swing in the ignitor pulse is +2700 Volts, the resulting ignition voltage to the lamp 202 is +3000 Volts. When the polarity of the instantaneous OCV is negative, the timing signal 224 directs the level shifter 80 to close the second switch 126 and open the first switch 106, so the initial swing in the ignition pulse is negative. This subtracts the power pulse voltage from the instantaneous OCV. For example, when the instantaneous OCV is −300 Volts and the initial swing in the ignition pulse is −2700 Volts, the resulting ignition voltage to the lamp 202 is −3000 Volts. Those skilled in the art will appreciate that the pulse polarity mode can be used for ignitors with lamp power supplies providing AC power as a square wave or a sine wave. The effect in the superposition of like polarity instantaneous OCV with ignition pulse can be seen in FIG. 3C: the amplitude of consecutive ignition pulses on a single polarity OCV half cycle switches between consecutive ignition pulses, with the greater magnitude when the OCV and ignition pulse are of the polarity.

Referring to FIG. 5, the pulse polarity mode can optionally include operation in a synchronization mode in which the ignition pulse is synchronized with the AC power cycle to occur at a given time, or the synchronization mode can be used independently of the pulse polarity mode. During startup operation, the lamp feedback circuit 220 monitors the OCV signal 222 for zero crossing. After the lamp feedback circuit 220 detects a zero crossing, the timing signal 224 directs the level shifter 80 to change the state of the first switch 106 and the second switch 126 after a predetermined time. Thus, the ignition pulse occurs both with the desired like polarity as the OCV and at the desired time in the AC power cycle. When the AC power 212 is a square wave, the desired time can be selected so the ignition pulse occurs in a stable portion of the square wave. When the AC power 212 is a sine wave, the desired time can be selected so the ignition pulse occurs at the peak of the like polarity instantaneous OCV to maximize ignition pulse voltage to the lamp 202.

FIGS. 7A & 7B are voltage traces for an ignitor with lamp feedback employing a pulse polarity mode and synchronization mode for an HID lamp in accordance with the present invention. FIG. 7A is an example of the AC power as a square wave, such as delivered by an electronic HID ballast, with a single like polarity ignition pulse occurring each OCV half cycle. FIG. 7B is an example of the AC power as a sine wave, such as delivered by an electro-magnetic ballast, with a single like polarity ignition pulse synchronized to the peak of each OCV half cycle.

FIG. 8 is a schematic diagram of another embodiment of an ignitor for an HID lamp in accordance with the present invention. Lamp feedback allows the ignition pulses to be coordinated with the open circuit voltage to the lamp. The lamp ballast can operate in a pulse polarity mode and/or in a synchronization mode.

Lamp ballast 300 provides power to a lamp 302 at lamp output 398. The lamp ballast 300 includes an ignitor 390, a lamp power supply 310, and a lamp feedback circuit 320. The lamp power supply 310 provides AC power 312 to the lamp 302 during and after ignition. In one embodiment, the AC power 312 is a square wave, such as provided by an electronic HID ballast. In another embodiment, the AC power 312 is a sine wave, such as delivered by an electro-magnetic ballast. The lamp feedback circuit 320 is responsive to an open circuit voltage (OCV) signal 322 to alternately generate a first switch timing signal 312 and a second switch timing signal 332 provided to the ignitor 390.

The ignitor 390 includes a first switch 306, second switch 326, and a center tap transformer 392. The center tap of the primary winding 394 of the center tap transformer 392 is operably connected to DC voltage 302 and the ends of the primary winding 394 are operably connected to common 324 through the first switch 306 and second switch 326. The first switch 306 is responsive to the first switch timing signal 312 and the second switch 326 is responsive to the second switch timing signal 332. The first switch 306 and second switch 326 can be field effect transistors (FETs), bipolar transistors, or insulated gate bipolar transistors (IGBTs). The lamp 302 is operably connected to the lamp power supply 310 through the secondary winding 396 of the center tap transformer 392.

During startup operation, the lamp feedback circuit 320 monitors the OCV signal 322. For operation in the pulse polarity mode, the first switch timing signal 312 directs the first switch 306 to close and the second switch timing signal 332 directs the second switch 326 to remain open when the lamp feedback circuit 320 determines that the instantaneous OCV is positive. The current through the primary winding 394 generates an ignition pulse of the same positive polarity as the instantaneous OCV. When the lamp feedback circuit 320 determines that the instantaneous OCV is negative, the second switch timing signal 332 directs the second switch 326 to close and the first switch timing signal 312 directs the first switch 306 to remain open. The current through the primary winding 394 generates an ignition pulse of the same negative polarity as the instantaneous OCV.

For operation in the synchronization mode during startup operation, the lamp feedback circuit 320 monitors the OCV signal 322 for zero crossing. The lamp feedback circuit 320 directs closure of one of the first switch 306 or the second switch 326 a predetermined time after the lamp feedback circuit 320 detects a zero crossing. The lamp feedback circuit 320 generates the first switch timing signal 312 which directs the first switch 306 to close to generate a positive ignition pulse. The lamp feedback circuit 320 generates the second switch timing signal 332 which directs the second switch 326 to close to generate a negative ignition pulse. The predetermined time can be selected so the ignition pulse is synchronized with the desired point in the AC power 312. The synchronization mode can be used in conjunction with the pulse polarity mode to generate an ignition pulse of the same polarity as the AC power synchronized to the desired point on the AC power. FIGS. 7A & 7B as discussed above provide exemplary voltage traces for operation in the pulse polarity mode and synchronization mode.

While the embodiments of the invention disclosed herein are presently considered to be preferred, various changes and modifications can be made without departing from the scope of the invention. For example, those skilled in the art will appreciate that switches other than transistors can be used as desired for a particular application. The scope of the invention is indicated in the appended claims, and all changes that come within the meaning and range of equivalents are intended to be embraced therein.

1. An ignitor for a lamp, the ignitor comprising:
a transformer (92) having a primary winding (94) inductively coupled to a secondary winding (96), the secondary winding (96) being operably connected to a lamp output (98) operable to receive the lamp;
a first switch circuit (100) operably connected between DC voltage (102) and a junction point (104), the first switch circuit (100) being responsive to a first switch signal (112);
a second switch circuit (120) operably connected between the junction point (104) and common (124), the second switch circuit (120) being responsive to a second switch signal (132); and
an LC tank circuit (140) having the primary winding (94) operably connected in series with a capacitor (142), the LC tank circuit (140) being operably connected between the junction point (104) and the common (124);
wherein the first switch signal (112) alternates with the second switch signal (132) to close the first switch circuit (100) and the second switch circuit (120).

2. The ignitor of claim 1 wherein a level shifter (80) generates the first switch signal (112) and the second switch signal (132) in response to a timing signal (72).

3. The ignitor of claim 2 wherein a timer (70) generates the timing signal (72).

4. The ignitor of claim 1 further comprising a transient voltage suppressor (TVS)(160) operably connected in parallel with the primary winding (94).

5. The ignitor of claim 1 further comprising a full wave bridge (170) operably connected across the primary winding (94) and operably connected to the DC voltage (102).

6. The ignitor of claim 1 further comprising:
a lamp power supply (210) operably connected to provide AC power (212) to the lamp output (98) and generate an open circuit voltage (OCV) signal (222) in response to the AC power (212); and
a lamp feedback circuit (220) responsive to the open circuit voltage (OCV) signal (222).

7. The ignitor of claim 6 wherein the lamp feedback circuit (220) is responsive to the open circuit voltage (OCV) signal (222) to generate a lamp operation state signal (226), the lamp power supply (210) being responsive to the lamp operation state signal (226) to switch the AC power (212) between a first frequency and a second frequency.

8. The ignitor of claim 6 wherein:
a level shifter (80) generates the first switch signal (112) and the second switch signal (132) in response to a timing signal (72);
the lamp feedback circuit (220) is responsive to the open circuit voltage (OCV) signal (222) to generate a timing signal (224);
the level shifter (80) is responsive to the timing signal (224) to close the first switch circuit (100) when the open circuit voltage (OCV) signal (222) indicates polarity of the AC power (212) is positive; and
the level shifter (80) is responsive to the timing signal (224) to close the second switch circuit (120) when the open circuit voltage (OCV) signal (222) indicates the polarity of the AC power (212) is negative.

9. The ignitor of claim 6 wherein:
a level shifter (80) generates the first switch signal (112) and the second switch signal (132) in response to a timing signal (72);
the lamp feedback circuit (220) is responsive to the open circuit voltage (OCV) signal (222) to generate a timing signal (224); and
the level shifter (80) is responsive to the timing signal (224) to close one of the first switch circuit (100) and the second switch circuit (120) a predetermined time after the open circuit voltage (OCV) signal (222) indicates zero crossing for the AC power (212).

10. The ignitor of claim 6 wherein:
a level shifter (80) generates the first switch signal (112) and the second switch signal (132) in response to a timing signal (72);
the lamp feedback circuit (220) is responsive to the open circuit voltage (OCV) signal (222) to generate a timing signal (224);
the level shifter (80) is responsive to the timing signal (224) to close the first switch circuit (100) a predetermined time after the open circuit voltage (OCV) signal (222) indicates polarity of the AC power (212) is positive; and
the level shifter (80) is responsive to the timing signal (224) to close the second switch circuit (120) a predetermined time after the open circuit voltage (OCV) signal (222) indicates the polarity of the AC power (212) is negative.

11. An ignitor for a lamp, the ignitor comprising:
a transformer (92) having a primary winding (94) inductively coupled to a secondary winding (96), the secondary winding (96) being operably connected to a lamp output (98) operable to receive the lamp;
an LC tank circuit (140) having the primary winding (94) operably connected in series with a capacitor (142), the LC tank circuit (140) being operably connected between a junction point (104) and common (124); and
means for switching the junction point (104) between DC voltage (102) and the common (124) at a predetermined frequency.

12. The ignitor of claim 11 further comprising means for limiting voltage across the primary winding (94) to a predetermined voltage.

13. The ignitor of claim 11 further comprising means for recovering energy from the means for limiting voltage.

14. The ignitor of claim 11 further comprising:
a lamp power supply (210) operably connected to provide AC power (212) to the lamp output (98); and
means for switching the AC power (212) between a first frequency when the lamp is in startup operation and a second frequency when the lamp (202) is in steady state operation.

15. The ignitor of claim 11 wherein the switching means generates ignition pulses at the lamp output (98), the ignitor further comprising:
a lamp power supply (210) operably connected to provide AC power (212) to the lamp output (98); and
means for maintaining like polarity between the ignition pulses and the AC power (212).

16. An ignitor system for a lamp, the ignitor system comprising:
a timer (70) operable to generate a timing signal (72);
a level shifter (80) responsive to the timing signal (72) to generate a first switch signal (112) and a second switch signal (132);
a transformer (92) having a primary winding (94) inductively coupled to a secondary winding (96), the secondary winding (96) being operably connected to a lamp output (98) operable to receive the lamp;
a first switch circuit (100) operably connected between DC voltage (102) and a junction point (104), the first switch circuit (100) having a first switch (106) operably connected in parallel with a first diode (108), the first switch (106) being responsive to the first switch signal (112), a first diode cathode (110) of the first diode (108) being operably connected to the DC voltage (102);
a second switch circuit (120) operably connected between the junction point (104) and common (124), the second switch circuit (120) having a second switch (126) operably connected in parallel with a second diode (128), the second switch (126) being responsive to the second switch signal (132), a second diode cathode (130) of the second diode (128) being operably connected to the junction point (104); and
an LC tank circuit (140) having the primary winding (94) operably connected in series with a capacitor (142), the LC tank circuit (140) being operably connected between the junction point (104) and the common (124);
wherein the first switch signal (112) alternates with the second switch signal (132) to alternately close the first switch (106) and the second switch (126).

17. The ignitor system of claim 16 further comprising a voltage limiter operably connected in parallel with the primary winding (94).

18. The ignitor of claim 16 further comprising:
a lamp power supply (210) operably connected to provide AC power (212) to the lamp output (98) and generate an open circuit voltage (OCV) signal (222) in response to the AC power (212); and
a lamp feedback circuit (220) responsive to the open circuit voltage (OCV) signal (222).

19. The ignitor of claim 18 wherein the lamp feedback circuit (220) is responsive to the open circuit voltage (OCV) signal (222) to generate a lamp operation state signal (226), the lamp power supply (210) being responsive to the lamp operation state signal (226) to switch the AC power (212) between a first frequency and a second frequency.

20. The ignitor of claim 18 wherein:
the lamp feedback circuit (220) is responsive to the open circuit voltage (OCV) signal (222) to generate a timing signal (224);
the level shifter (80) is responsive to the timing signal (224) to close the first switch (106) when the open circuit voltage (OCV) signal (222) indicates polarity of the AC power (212) is positive; and
the level shifter (80) is responsive to the timing signal (224) to close the second switch (126) when the open circuit voltage (OCV) signal (222) indicates the polarity of the AC power (212) is negative.

21. The ignitor of claim 18 wherein:
the lamp feedback circuit (220) is responsive to the open circuit voltage (OCV) signal (222) to generate a timing signal (224); and
the level shifter (80) is responsive to the timing signal (224) to close one of the first switch (106) and the second switch (126) a predetermined time after the open circuit voltage (OCV) signal (222) indicates zero crossing for the AC power (212).
